(19) United States
(12) Patent Application Publication
(10) Pub. No.: US 2015/0136560 A1
(43) Pub. Date: May 21, 2015

(54) HYDRAULIC PISTON SYSTEM

(71) Applicant: Caterpillar Inc., Peoria, IL (US)

(72) Inventors: AMOGH A. DEO, PEORIA, IL (US); MATTHEW T. BOBER, METAMORA, IL (US); JAMIE W. CLARK, GERMANTOWN HILLS, IL (US); MATTHEW A. HANKS, EAST PEORIA, IL (US); ROBERT E. CAYLOR, PEORIA, IL (US); MARK A. BATDORFF, WASHINGTON, IL (US); PERRY G. CRUCE, MARQUETTE HEIGHTS, IL (US)

(73) Assignee: Caterpillar Inc., Peoria, IL (US)

(21) Appl. No.: 14/606,040

(22) Filed: Jan. 27, 2015

(51) Int. Cl. F16D 25/12; F16D 25/06

(52) U.S. Cl. CPC F16D 25/12; F16D 25/06
USPC 192/85.17

(57) ABSTRACT

A hydraulic piston system includes a housing that defines a piston pocket and a fluid inlet. A piston with a peripheral region and an end is movable within the piston pocket of the housing. The end of the piston has peripheral defined channels and a portion structured and arranged to engage the housing to limit travel of the piston. Further, a seal is configured to seal the peripheral region of the piston against the piston pocket. The seal is structured and arranged to receive fluid pressure when the piston is positioned with the portion of the piston is in engagement with the housing and fluid communication exists between the fluid inlet and the seal through the peripheral defined channels.

### TECHNICAL FIELD

The present disclosure relates generally to the inflation of piston seals in speed clutches. More specifically, the present disclosure relates to inflation of piston seals, which facilitates positive piston sealing.

### BACKGROUND

Generally, powershift transmissions in construction machines include a number of gear elements that couple to associated input and output shafts. A related number of clutches are selectively engaged to activate those gear elements to establish a desired speed ratio between the input and output shafts. The clutch may be one of a band or a disk type. The input shaft may be connected to the engine through a fluid coupling, such as a torque converter, while the output shaft may be connected directly to a final drive. A shift from one gear ratio to another generally involves a release of an off-going clutch associated with a current gear ratio, and a subsequent application of an on-coming clutch associated with a desired gear ratio.

To enable precise shift timings, an appropriate fill of an on-coming clutch cavity with a relevant fluid is required. During the fill period, the clutch piston strokes and affiliated clutch plates compress. Given such periodic clutch movement, seals associated with clutch pistons may wear and lose shape over time. As a result, gaps are generally formed between an associated piston bore and the clutch piston. Such gap formation may lead to inconsistent pressure development and delayed clutch response. More particularly, the clutch may not transmit torque until the clutch plate is adequately compressed.

U.S. Pat. No. 5,680,919 discloses a clutch device that reduces clutch slippage time and provides for a relatively quick shift, while also preventing shocks associated with shift operations in an automatic transmission assembly. Although this reference focuses towards a relatively rapid clutch operation, a solution that may help correct inconsistent clutch fills, particularly at relatively high temperatures is not provided.

Accordingly, the system and method of the present disclosure solves one or more problems set forth above and/or other problems in the art.

### SUMMARY OF THE INVENTION

Various aspects of the present disclosure illustrate a hydraulic piston system, which includes a housing that defines a piston pocket and a fluid inlet. Further, a piston with a peripheral region and an end is movable within the piston pocket of the housing. The end of the piston includes peripheral defined channels. A portion is structured and arranged that engages the housing and limits travel of the piston. Moreover, a seal is configured to seal the peripheral region of the piston against the piston pocket. The seal is structured and arranged to receive fluid pressure with the piston positioned with the portion of the piston in engagement with the housing. In addition, fluid communication exists between the fluid inlet and the seal via the peripheral defined channels.

### BRIEF DESCRIPTION OF THE DRAWINGS

FIG. 1 is a cross-sectional view of a hydraulic system incorporated with an exemplary hydraulic piston system, in accordance with the concepts of the present disclosure;

FIG. 2 is an enlarged view of the hydraulic piston system of FIG. 1, which includes an exemplary speed clutch piston, in accordance with the concepts of the present disclosure;

FIG. 3 is a close-up sectional view of the speed piston clutch of the hydraulic piston system and the environment that surrounds the speed clutch piston, in accordance with the concepts of the present disclosure; and

FIG. 4 is an isometric view of the speed clutch piston, in accordance with the concepts of the present disclosure.

### DETAILED DESCRIPTION

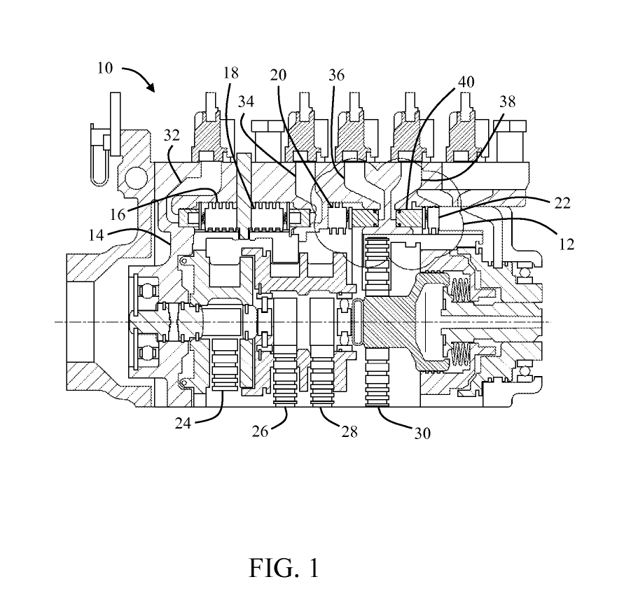

Referring to FIG. 1, there is shown a cross-sectional view of a hydraulic system 10. The hydraulic system 10 may be a powershift transmission assembly of a construction machine (not shown). The construction machine may be a track-type tractor, for example. However, aspects of the present disclosure may be applied to other machine types, such as but not limited to, hydraulic excavators, skid-steer loaders, wheel loaders, backhoe loaders, paving machines, articulated trucks, mining trucks, and/or the like. An extension of the application may also be contemplated to stationery machines, such as generators, heavy machines, and/or other power-generation units applicable for domestic and commercial use. Marine application is another area where one or more aspects of the present disclosure may be suitably employed.

The hydraulic system 10, which may be a power-shift transmission, may be one of the commonly applied transmission assemblies in the art. The depicted embodiment showcases a unit, which includes a hydraulic piston system 12 within a housing 14. The housing 14 includes a first direction clutch 16 and a second direction clutch 18, interchangeably referred to as set of direction clutches 16 and 18, hereinafter. Further, a first speed clutch 20 and a second speed clutch 22, also referred to as a set of speed clutches 20 and 22 for convenience, are housed within the housing 14, as well. The set of direction clutches 16 and 18 engage respective to a set of direction gears (first direction gear 24 and second direction gear 26). Similarly, the set of speed clutches 20 and 22 engage to a set of speed gears (first speed gear 28 and second speed gear 30). The first direction gear 24 and second direction gear 26 facilitate a change in direction (forward or reverse) of the machine (not shown), while the set of first speed gear 28 and the second speed gear 30 facilitate a change in speed.

A first direction clutch passage 32 is defined within the housing 14 to facilitate a pressurized fluid flow and operable communication with the first direction clutch 16. Similarly, a second direction clutch passage 34 is defined relative to the second direction clutch 18. As with this arrangement, a first speed clutch passage 36 is defined within the housing 14 to facilitate a pressurized fluid flow and operable communication with the first speed clutch 20. Similarly, a second speed clutch passage 38 is defined relative to the second speed clutch 22. Although passages 32, 34, 36, and 38, may be structured to allow gravity feed of the hydraulic fluid flow, multiple other configurations and profile of the passages 32, 34, 36, and 38, may be contemplated. Notably, each of the passages 32, 34, 36, and 38, includes a clutch piston to facilitate operable communication with each of the clutches 16, 18, 20, and 22. For ease of reference and understanding, however, the forthcoming application will describe details of the clutch piston (referred to as piston 40) disposed relative to the second speed clutch passage 38 alone. It may be understood that details and embodiments discussed and contemplated for the piston 40 will be applicable to other pistons employed within the passages 32, 34, and 38.

Each of the clutches 16, 18, 20, and 22, may be one of a multi-disc clutch, dog clutch, and/or a friction clutch, actuated by hydraulic pressure. Other clutch types may be contemplated. Upon engagement, it may be required to have a desired hydraulic fluid fill into the passages 32, 34, 36, and 38, to facilitate torque transfer between a related driver element and a driven element. An associated fluid fill time may be understood as the time elapsed between movement of the piston 40 from a released state to an engaged state. As conventionally known, the clutches 16, 18, 20, and 22, may be selectively engaged by a series of valves (not shown), which may be solenoid operated proportional pressure control valves, for example, that regulate a fluid flow. To facilitate a pressurized fluid flow, the associated hydraulic circuit may include a positive displacement pump (not shown) configured to supply pressurized hydraulic fluid from a sump or a reservoir (not shown). Moreover, one or more relief valves may be suitably employed to regulate a valve supply pressure.

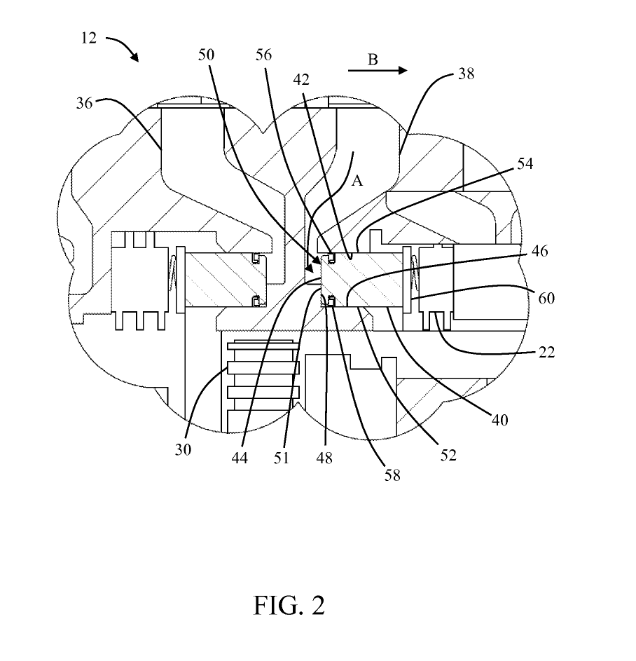

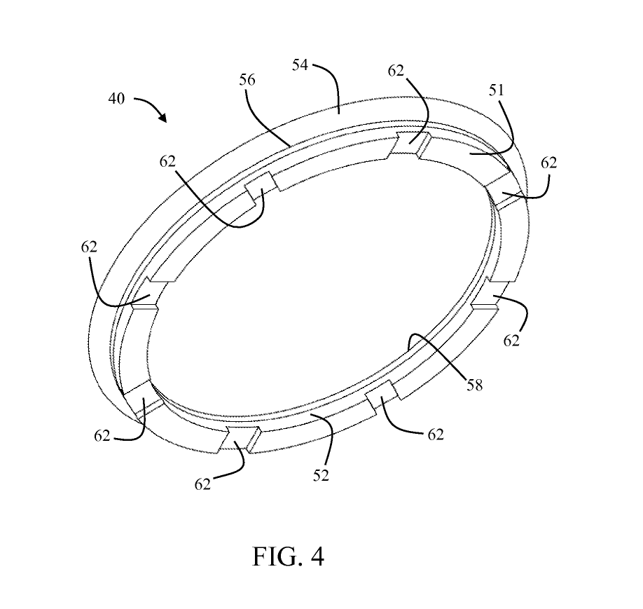

Referring to FIG. 2, the piston 40 and certain surroundings of the piston 40 are shown in greater detail, and in conformity with the cross-sectional view of FIG. 1. As shown, the piston 40 is positioned within a piston pocket 42 of the housing 14. Although not limited, the piston 40 may be a slug aluminum piston, substantially ring shaped (see FIG. 4), with a peripheral region. Given the ring-shaped profile, the piston 40 includes an inner peripheral region 52 and an outer peripheral region 54 (better visualized in FIG. 4). The aspects of the present disclosure may refer to the peripheral region of piston 40 as the inner peripheral region 52 alone. However, this is not limited, and the principles discussed for the inner peripheral region 52 may be equivalently applied to the outer peripheral region 54 as well. Further, the piston 40 includes an end 50 with a portion 51, which is structured and arranged to engage the housing 14 to limit travel of the piston 40.

The piston 40 may be manufactured from cast iron, which accommodates substantially higher temperature levels of 90° C.-120° C. of the hydraulic fluid. Although a cast iron-based structure is contemplated for the piston 40, multiple other materials may be suitable.

The piston pocket 42 may be structured at an end of the passage 36, when seen along an exemplary flow direction, A, of the hydraulic fluid. The piston pocket 42 may comply with the outer confines of the piston 40. This compliance of shape allows the piston 40 to be movable between a seated position and an extended position within the piston pocket 42. Structurally, the passage 36 is in fluid communication with the piston pocket 42. More particularly, a fluid inlet 44 is defined at the passage end, or at an interface between the passage 36 and the piston pocket 42. The fluid inlet 44 allows entry to an inflowing fluid and facilitates subjection of the piston 40 to fluid pressure, during operations. The piston pocket 42 also includes a bore 46 and a bore bottom 48 within the housing 14.

In the depicted embodiment, the piston 40 is in a seated position, and disengaged relative to the second speed clutch 22. In this position, the piston 40 abuts and rests against the bore bottom 48. By implication, the fluid inlet 44 is substantially flush with the end 50 of the piston 40. An engaged position of the piston 40 relative to the second speed clutch 22 and a corresponding extended positioned may be envisioned along the direction, B. This extended position may result when an inflowing pressurized fluid flows through the fluid inlet 44 and pushes the piston 40 forward, along the direction, B.

An outer seal 56 may be positioned about the outer peripheral region 54, while an inner seal 58 may be positioned about the inner peripheral region 52. Both the outer seals 56 and the inner seal 58 are configured to seal the piston 40 against the bore 46 in the seated position as well as in the extended position. An outer face 60 of the piston 40 may engage with the second speed clutch 22. Although concepts of the present disclosure are directed towards a working of the inner seal 58, a functioning of the outer seal 56 may benefit from the aspect of the present disclosure as well.

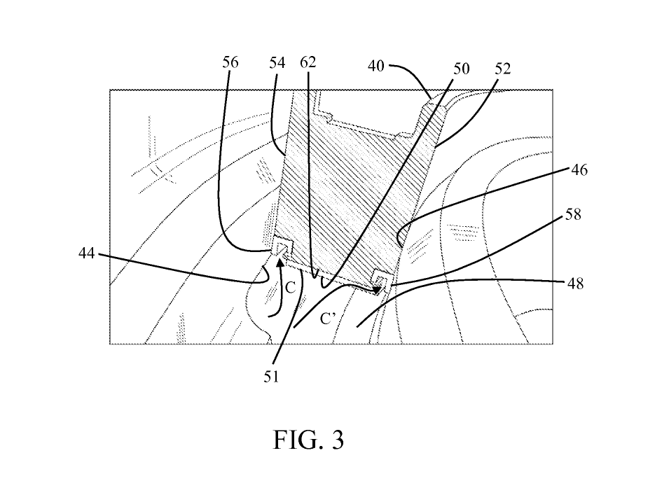

Referring to FIG. 3, a profile of the outer seal 56 and the inner seal 58 is better understood. Both the outer seal 56 and the inner seal 58 include a substantially U-shaped structure. As shown in this view, the outer seal 56 and the inner seal 58 are in an inverted U-shaped orientation. The U-shaped structure of the outer seal 56 and the inner seal 58 provide a region into which hydraulic fluid may enter during operation (or when an extended position is initiated). As a result, the outer seal 56 and the inner seal 58, may inflate, abut, and seal even more positively against the bore 46. The inner seal 58 (or simply seal 58, hereinafter) is configured to seal the inner peripheral region 52 of the piston 40 against the piston pocket 42.

A characteristic feature of the piston 40 is also shown. The end 50 includes peripheral defined channels 62, or simply channels 62, hereinafter, which are better visualized in FIG. 4. To this end, the channels 62 extend radially from the outer peripheral region 54 to the inner peripheral region 52. In that manner, a positive fluid communication is established between the fluid inlet 44 and the seal 58, even when the piston 40 is in the seated position. More particularly, the seal 58 is structured and arranged to receive fluid pressure when the portion 51 of the piston 40 is engaged (in the seated position) with the housing 14 (or the bore bottom 48), and fluid communication exists between the fluid inlet 44 and the seal 58 through the channels 62 (better visualized in FIG. 4).

Although a profile of the channels 62 extend from the outer peripheral region 54 to the inner peripheral region 52, a varying channel length may be contemplated. As an example, channels 62 may also extend from a substantial midway region of the end 50, to the inner peripheral region 52, while also maintaining fluid communication between the fluid inlet 44 and the seal 58 in the seated position of the piston 40.

Also shown in the view are exemplary fluid flow lines, depicted by the direction, C, and direction, C′. Notably, direction, C, corresponds to the fluid flow towards the outer seal 56, whereas direction, C′ corresponds to the direction of fluid flow towards the seal 58.

Referring to FIG. 4, a further detailed view of the piston 40 is shown. More particularly, the ring-shaped structure and the slotted design of the channels 62 of the piston 40 may more clearly visualized. Although the channels 62 are shown as eight in number here, a variable number may be envisioned. The channels 62 may include a right-angled, straight-cut profile, as shown. However, the channels 62 may be structured at an angle relative to the contours of the piston 40. Further, a shape of the channels 62 need not be seen as limiting, and accordingly, the channels 62 may include curvatures, grooves, and/or other profile specific features, that may assist in delivery of the hydraulic fluid to the seal 58 during a seated position of the piston 40. Irregular profiles of the channels 62 may be contemplated as well.

Other configurations and arrangements of the channels 62 may also be envisioned. For example, one or more fluid passages or channels may be built into the piston structure that extend from the end 50 to the seal 58 for ensuring a fluid communication between the end 50 and the seal 58. An embodiment with a singular channel 62 may also be contemplated.

### INDUSTRIAL APPLICABILITY

During operation, an input by a user or an operator may initiate a gearshift procedure. An automatic input may be contemplated as well. After initiation, hydraulic flow at an off-going clutch (for example, the first speed clutch 20) may recede, accompanying a reduction in pressure, while at an on-coming clutch (for example, the second speed clutch 22) a hydraulic flow may advance, thereby pressurizing the piston 40. An associated flow occurs through the second speed clutch passage 38 (or hydraulic passage), along a direction, A, as noted above (see FIG. 2). When the fluid inlet 44 is reached, the hydraulic fluid comes in contact with the end 50. Before a resultant hydraulic push is imparted, the hydraulic fluid will flow into the U-shaped outer seal 56 and inner seal 58. More particularly, the outer seal 56 may be subject to a quicker inflow because of a ready fluid communication path (direction, C). However, a fluid communication (and a fluid flow) to the seal 58 is facilitated in an auxiliary direction, C′ (see FIG. 3), through the channel 62.

Subsequently, the incoming flow would fill the outer seal 56 and the inner seal 58, causing the outer seal 56 and inner seal 58 to inflate, expand, and abut substantially tightly against the bore 46. In so doing, gaps and clearances between the piston 40 and the bore 46 are secured in a timely fashion and a consistent fluid filling operation is established. This may occur before fluid pressure at an off-going clutch is fully released. More particularly, pressure in the off-going clutch is reduced, while the on-coming clutch (piston 40) is provided with a fill of hydraulic fluid. The on-coming clutch (piston 40) is then ramped up, while ramping down the off-going clutch to ensure a smooth transition. A consequent push is then imparted to the piston 40 in the direction, B (see FIG. 2), which in turn pushes the second speed clutch 22, thereby facilitating a positive engagement with the second speed gear 30. Issues with shift quality are thus reduced given consistent and a timely fluid fill. This decreases work time and increases customer satisfaction.

Moreover, relatively high temperature may cause seal creep and create considerably large gaps between the piston 40 and the bore 46. The usage of cast iron-based pistons (piston 40) reduces those effects of heat and thermal expansion. The cast iron based piston 40, therefore, may be suitable for a generally higher temperature range of 90° C.-100° C.

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. A hydraulic piston system comprising:
a housing defining a piston pocket and a fluid inlet;
a piston having a peripheral region, and movable within the piston pocket of the housing, the piston having an end, the end of the piston having peripheral defined channels, and having a portion structured and arranged to engage the housing to limit travel of the piston; and
a seal configured to seal the peripheral region of the piston against the piston pocket, wherein the seal being structured and arranged to receive fluid pressure with the piston positioned with the portion of the piston being engaged with the housing and fluid communication between the fluid inlet and the seal being through the peripheral defined channels.
